(19) United States
(12) Patent Application Publication
(10) Pub. No.: US 2007/0177621 A1
(43) Pub. Date: Aug. 2, 2007

(54) Control method and system for packet transmission

(75) Inventors: Chung-Ping Chang, Taipei (TW); Yun-Fei Chao, Taipei (TW); Chun-Cheng Wang, Taipei (TW); Wei-Pin Chen, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies Inc.

(21) Appl. No.: 11/344,807

(22) Filed: Feb. 1, 2006

(51) Int. Cl. H04L 12/56

(52) U.S. Cl. 370/412

(57) ABSTRACT

A control system for packet transmission. A forward control unit receives a packet providing a port count through an input port and implements a lookup operation. A queue control unit determines whether the port count is greater than a first predetermined value, and, if not, outputs the packet through a first port, and, if so, sends a first message. A multicast forward control unit receives the first message, adds one to a first packet count, determines whether the first packet count is greater than a threshold value, and, if so, sends a stop forward message to the forward control unit but does not send a grant message. The forward control unit receives the stop forward message and does not transmit subsequent packets to the first port but to a second port directly.

### BACKGROUND OF THE INVENTION

1. Field of the Invention

The present invention relates to packet transmission, and in particular to a control method and system for packet transmission.

2. Description of the Related Art

A network switch creates a local area network (LAN) among a plurality of end nodes, such as workstations, and other network switches connected thereto. Each end node is connected to one port of the network. The ports also serve to connect network switches together. Each end node sends packets of data to the network switch which the switch then routes either to another of the end nodes connected thereto or to a network switch into which the destination end node is connected. Additionally, the receiving network switch routes the packet to the destination end node. Each network switch most temporarily stores the packets of data received from the units, end node or network switch, connected to it while the switch determines how, when and through which port to retransmit the packets. Each packet can be transmitted to only one destination address (a “unicast” packet) or to more than one unit (a “multicast” or “broadcast” packet). With respect to multicast and broadcast packets, the switch typically stores the packet only once and transmits multiple copies of the packet to some (multicast) or all (broadcast) of its ports. Once the packet has been transmitted to all of its destinations, it can be removed from the memory of the switch or written over. Each end node has an address, known as a media access control (MAC) address, which is unique to that end node. Each switch maintains an address-table, where each entry is composed of a MAC address and at least its device and port location on that end node.

An example of congested multicast transmission using a switch is described in the following.

Five multicast packets (PKT1, PKT2, PKT3, PKT3, PKT4, and PKT5) in port 1 are waiting to be sent, as shown in FIG. 1. When port 1 sends PKT1 out, it also queues PKT1 to port 2, as shown in FIG. 2. Next, when port 2 sends PKT1 out, it then queues PKT1 to port 3, while port 1 sends out and queues PKT2 to port 2, as shown in FIG. 3. The described method implements multicast packet delivery.

FIG. 4 is a schematic view of the architecture of a conventional packet transmission system. The system comprises a queue control unit 110, a forward control unit 120, a dequeue control unit 130, a static random access memory (SRAM) 140, and ports 1, 2, and 3. Port 1 comprises an input control unit 151 and an output control unit 152. Port 2 comprises an input control unit 161 and an output control unit 162. Port 3 comprises an input control unit 171 and an output control unit 172. SRAM 140 further comprises buffer 141 and buffer 142. Buffer 141 comprises queue 1 (not shown) to queue packets for port 1, queue 2 (not shown) to queue packets for port 2, and queue 3 (not shown) to queue packets for port 3. Buffer 142 can temporarily store a packet. It is noted that the packet transmission system can be applied to a switch, in which each function block can represent a hardware component to perform packet transmission described in the following.

A port count (PC) is defined for packet transmission determination. When PC =1, unicast packet transmission is implemented. When PC>1, multicast or broadcast packet transmissions are implemented. Input control unit 152 receives a packet comprising a PC value and sends a lookup request to forward control unit 120. The packet is stored in queue 1 (not shown). When the lookup request is received, forward control unit 120 determines the number of destination ports according to a lookup table to locate desired destination ports. The lookup table at least comprises port numbers and MAC addresses corresponding thereto, such that packets can be accurately transmitted to destination ports. When the destination port determination is complete, forward control unit 120 transmits the packet to queue control unit 110, in which the step indicates an input queuing operation. Queue control unit 110 receives and queues the packet from queue 1 to queue 2 and transmits queuing information to SRAM 140.

Next, when a destination port (port 2, for example) is available, it sends a dequeue request to dequeue control unit 130. Dequeue control unit 130 then retrieves the queuing information from SRAM 140, sends the queuing information to output control unit 162, enables output control unit 162 to output a copy of the packet (the step indicates a dequeuing operation), and subtracts 1 from the PC value. Next, it is determined whether the PC value of the packet is greater than 0. If not, indicating the packet is a unicast packet, the packet transmission process terminates. If the PC value is greater than 0, indicating the packet should be output via another destination port (port 3, for example), dequeue control unit 130 sends an output queuing: request to queue control unit 110 (the step indicates an output queuing operation). Queue control unit 110 receives the request and queues the packet from queue 2 to queue 3. When port 3 is available, it sends a dequeue request to dequeue control unit 130. Dequeue control unit 130 then retrieves the queuing information from SRAM 140, sends the queuing information to output control unit 172, enables output control unit 172 to output a copy of the packet (the step indicates a dequeuing operation), and subtracts 1 from the PC value. Next, it is determined whether the PC value of the packet is greater than 0. If not, the packet transmission process terminates.

FIG. 5 is a flowchart of a conventional method for packet transmission.

A port count (PC) is first defined for packet transmission determination (step S11). When PC=1, unicast packet transmission is implemented. When PC>1, multicast or broadcast packet transmissions are implemented. A packet comprising a PC value is received via an input port and stored in a first queue of the input port (step S12) A lookup operation is executed according to a lookup table to locate desired destination ports (step S13). The lookup table at least comprises port numbers and MAC addresses corresponding thereto, such that packets can be accurately transmitted to destination ports. When at least one desired destination port is located, the packet is queued from the first queue to a second queue of the desired port (step S14).

Next, when a destination port (port 2, for example) is available, the packet is output through port 2 according to a dequeue request and the PC value is subtracted by 1 (step S15). It is determined whether the PC value of the packet is greater than 0 (step S16). If not, the packet transmission process terminates (step S17). If so, the process proceeds to step S14 and a copy of the packet is output through another destination port (port 3, for example).

As described, the current packet transmission method, system, or apparatus can accurately transmit packets to destination ports but may result in network congestion.

An example of congested multicast transmission using a switch is described in the following. Ports 1 and 3 are large bandwidth (100 Mbps) ports. Port 1 comprises multiple packets and queues packets (PKT2, PKT3, . . . , and PKTn) to port 2, as shown in FIG. 6. Port 2 is not a large bandwidth port (1 Mbps) and is congested by excessive packets. Since port 2 is a congestion port, if drop control is implemented on port 2 for better flow ability, packets in port 1 are not queued to port 2 but to port 3, and, presently, port 2 sends out and queues PKT2 to port 3, which currently comprises PKT2 and PKTn+1. Thus, port 3 sends out PKTn+1 and then PKT2, resulting in an out of order, as shown in FIG. 7.

Thus, an improved method for solving congested packet transmission is desirable.

### BRIEF SUMMARY OF THE INVENTION

A control system for packet transmission is provided. The system comprises a first port, a second port providing a second packet count, a third port providing a third packet count, a storage medium, comprising a first queue applied to the first port, a second queue applied to the second port, and a third queue applied to the third port, a dequeue control unit, a forward control unit, a queue control unit, and a multicast forward control unit. The forward control unit receives a packet providing a port count through the first port, queues the packet in the first queue, implements a lookup operation according to a lookup table to locate desired destination ports, and, transmits the packet when the destination port determination is complete. The queue control unit receives and queues the packet from the first queue to the second queue, transmits first queuing information to the storage medium, determines whether the port count is greater than a predetermined value, and, if not, outputs the packet through the second port, and, if so, sends a first message. The multicast forward control unit receives the first message from the queue control unit, adds one to the second packet count, determines whether the second packet count is greater than a threshold value, and, if so, sends a stop forward message to the forward control unit but does not send a grant message. The forward control unit receives the stop forward message, does not queue subsequent packets from the first queue to the second queue but to the third queue directly, and requeues packets to the second queue when queued packets in the second queue are completely output.

A control method for packet transmission is provided. A second packet count applied to a second port, a third packet count applied to a third port, and a port count are defined. A packet is received through a first port and a lookup operation is implemented to locate desired destination ports. One is added to the second packet count when the port count is greater than a first predetermined value. It is determined whether the second packet count is greater than a threshold value, if so, subsequent packets are not transmitted to the second port but to the third port directly.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIGS. 1-3 are schematic views of an example of multicast packet transmission;

FIG. 4 is a schematic view of the architecture of a conventional packet transmission system;

FIG. 5 is a flowchart of a conventional method for packet transmission;

FIGS. 6 and 7 are schematic views of an example of congested multicast packet transmission;

FIG. 8 is a schematic view of an example of congested multicast packet transmission of the invention;

FIG. 9 is a schematic view of an embodiment of the architecture of a control system for packet transmission; and

FIG. 10 is a flowchart of an embodiment of a control method for packet transmission.

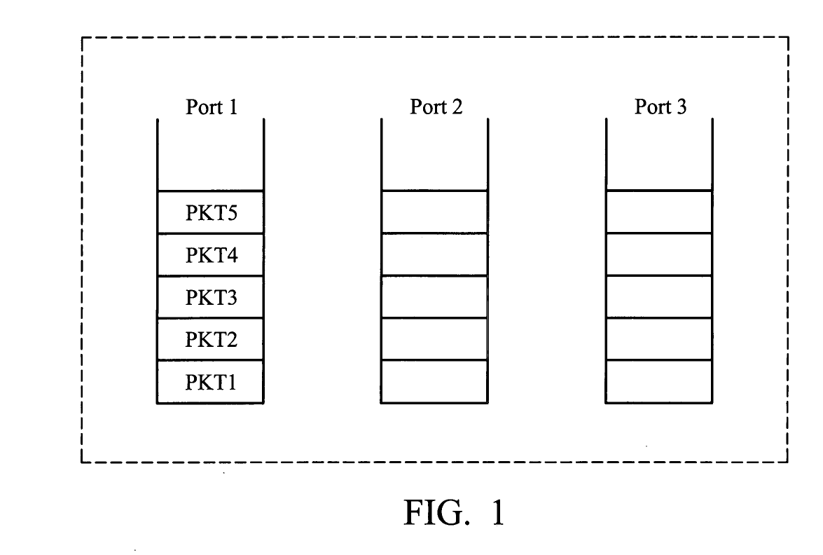

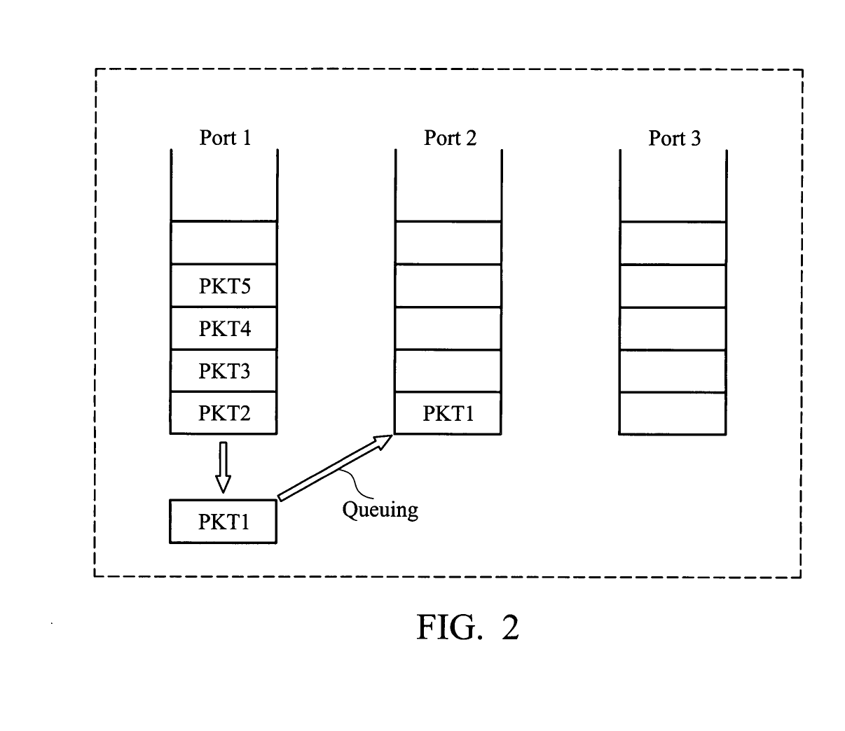

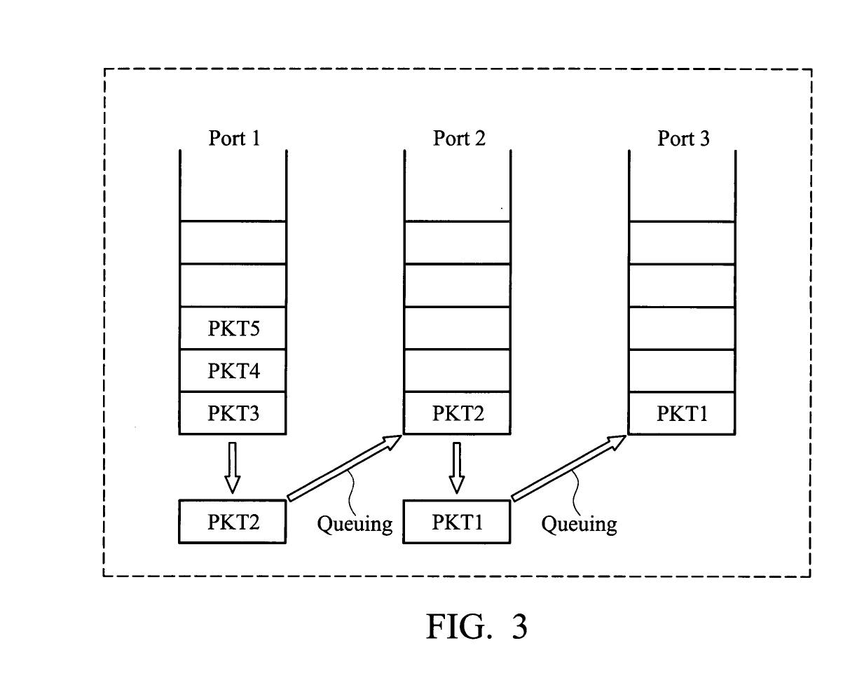

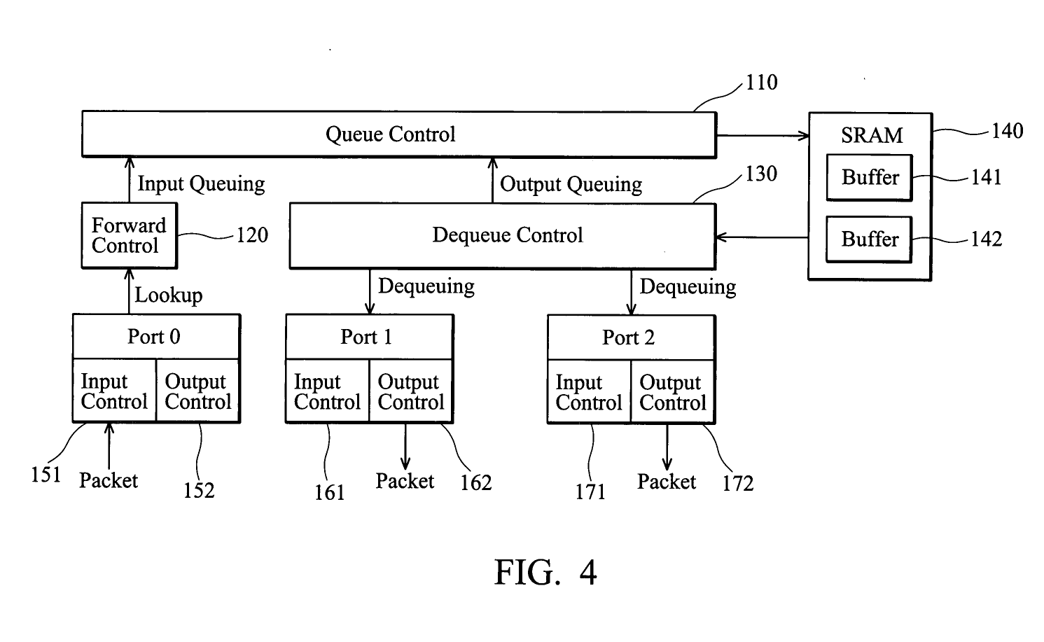

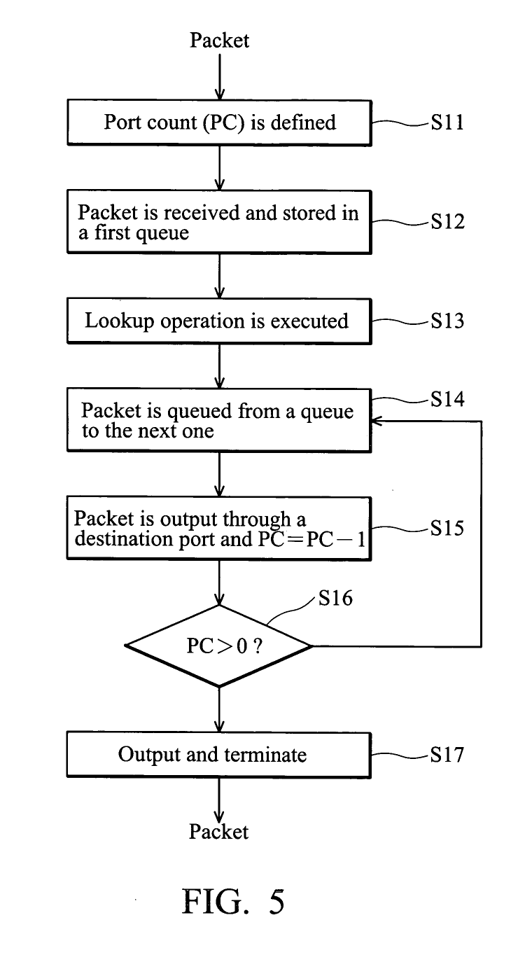

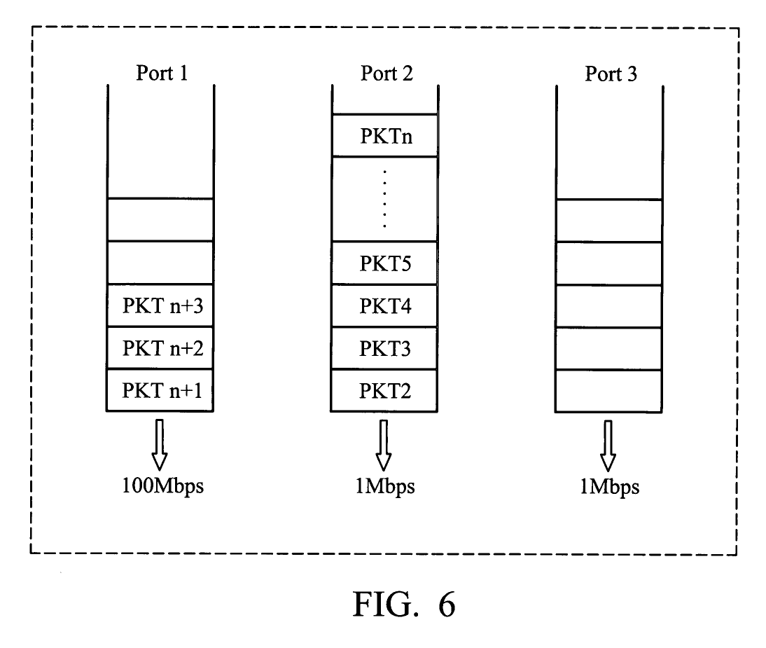

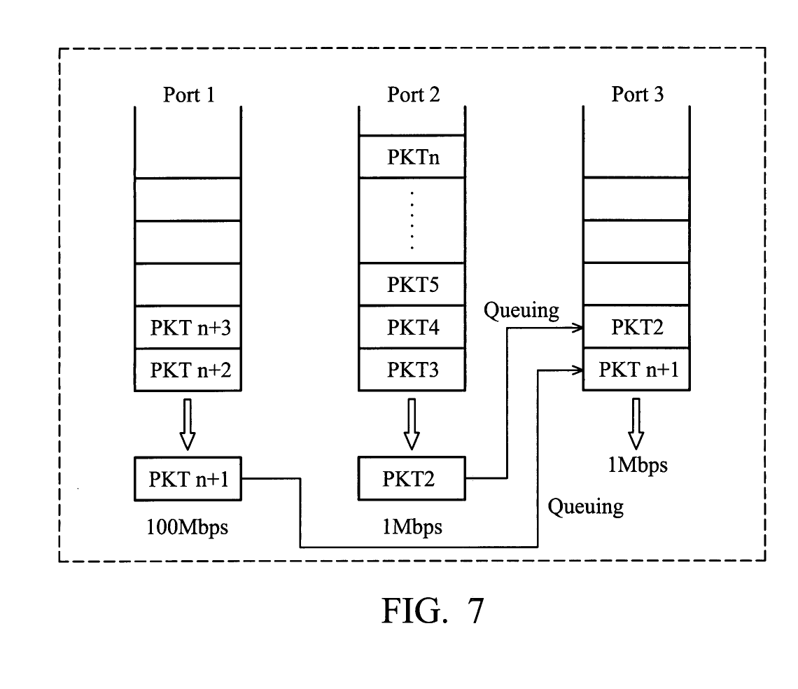

### DETAILED DESCRIPTION OF THE INVENTION

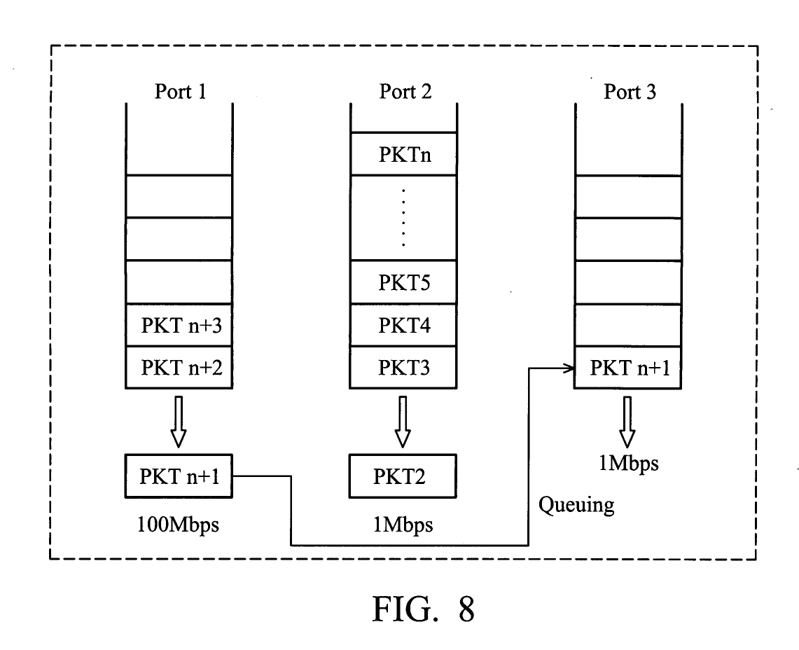

Several exemplary embodiments of the invention are described with reference to FIGS. 8 through 10, which generally relate to a control method for packet transmission. It is to be understood that the following disclosure provides many different embodiments as examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The invention discloses a control method and system for packet transmission.

The invention utilizes a quota to limit the number of multicast packets which a port can hold. Once a port queues packets greater than the limit value, no packet is queued to the port, thus avoiding an out of order of multicast packet sequence.

As shown in FIG. 8, ports 1 and 3 are large bandwidth (100 Mbps) ports. Port 1 comprises multiple packets and queues packets (PKT2, PKT3, . . . , and PKTn) to port 2. Since port 2 is not a large bandwidth port (1 Mbps) and is congested by excessive packets greater than a queue threshold (QT) value, packets in port 1 are not queued to port 2 but to port 3 while packets in port 2 are also not queued to port 3 but directly output.

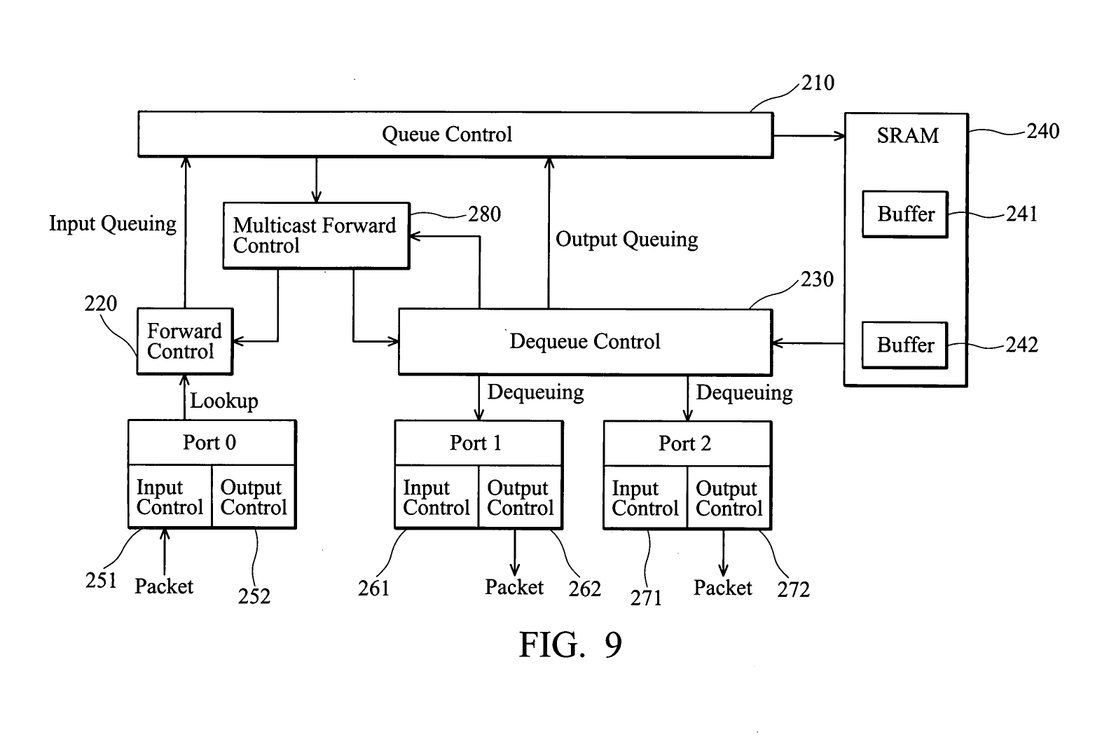

FIG. 9 is a schematic view of an embodiment of the architecture of a control system for packet transmission. The system comprises a queue control unit 210, a forward control unit 220, a dequeue control unit 230, SRAM 240, a multicast forward control unit 280, and ports 1, 2, and 3. Port 1 comprises an input control unit 251 and an output control unit 252. Port 2 comprises an input control unit 261 and an output control unit 262. Port 3 comprises an input control unit 271 and an output control unit 272. SRAM 140 further comprises buffer 241 and buffer 242. Buffer 241 comprises queue 1 (not shown) to queue packets for port 1, queue 2 (not shown) to queue packets for port 2, and queue 3 (not shown) to queue packets for port 3. Buffer 242 can temporarily store a packet. It is noted that the packet transmission system can be applied to a switch, in which each function block can represent a hardware component to perform packet transmission described in the following.

A port count (PC) and a queue threshold (QT) are defined for packet transmission determination. When PC=1, unicast packet transmission is implemented. When PC>1, multicast or broadcast packet transmissions are implemented. Further, each port is assigned a packet count (MCAST_CNT) to calculate the number of queued packets. In this embodiment, port 1 is an input port and ports 2 and 3 are output ports, but are not intended to be limitative.

Input control unit 252 receives a packet comprising a PC value and sends a lookup request to forward control unit 220. The packet is queued in queue 1 (not shown). When the lookup request is received, forward control unit 220 determines the number of destination ports according to a lookup table and congestion conditions relating to each port to locate desired destination ports. The lookup table at least comprises port numbers and MAC addresses corresponding thereto, such that packets can be accurately transmitted to destination ports. When the destination port determination is complete, forward control unit 220 transmits the packet to queue control unit 210, in which the step indicates an input queuing operation. Queue control unit 210 receives and queues the packet from queue 1 (not shown) to queue 2 (not shown) and transmits queuing information to SRAM 140. Next, queue control unit 210 determines whether the PC value of the packet is greater than 1. If not, the packet is output through a destination port and the packet transmission process terminates. If so, queue control unit 210 sends a message comprising the PC value and desired destination ports (ports 2 and 3, for example) to multicast forward control unit 280. When the message is received, multicast forward control unit 280 first adds one to MCAST_CNT_2 of port 2 and determines whether MCAST_CNT_2 is greater than the packet threshold. If not, multicast forward control unit 280 sends a grant message for port 2 (GNT_OQUEUE_2) to dequeue control unit 230. Dequeue control unit 230 retrieves the queuing information from SRAM 240, sends the queuing information to output control unit 262, enables output control unit 262 to output a copy of the packet (the step indicates a dequeuing operation), subtracts 1 from the PC value, and sends a subtraction message for queue 2 (SUBTRACT_PACKET_2) to multicast forward control unit 280 to subtract 1 from MCAST_CNT_2.

Dequeue control unit 230 then determines whether the PC value of the packet is greater than 0. If not, the packet transmission process terminates. If the PC value is greater than 0, indicating the packet should be output via another destination port (port 3, for example), dequeue control unit 230 sends an output queuing request to queue control unit 110 (the step indicates an output queuing operation). Queue control unit 210 then queues the packet from queue 2 (not shown) to queue 3 (not shown), transmits queuing information to SRAM 240, and sends a message for port 3 to multicast forward control unit 280. When the message is received, Multicast forward control unit 280 adds one to MCAST_CNT_3 of port 3 and determines whether MCAST_CNT 3 is greater than the packet threshold while queue control unit 210 receives the output queuing request and queues the packet from queue 2 to queue 3. If MCAST_CNT_3 is not greater than the packet threshold, multicast forward control unit 280 sends a grant message for port 3 (GNT_OQUEUE_3) to dequeue control unit 230. Dequeue control unit 230 retrieves the queuing information from SRAM 240, sends the queuing information to output control unit 272, enables output control unit 272 to output a copy of the packet when port 3 is available (the step indicates a dequeuing operation), subtracts 1 from the PC value, and sends a subtraction message for queue 3 (SUBTRACT_PACKET_3) to multicast forward control unit 280 to subtract 1 from MCAST_CNT_3. The described process repeats until all multicast packets are completely transmitted.

If MCAST_CNT_2 is greater than the packet threshold, multicast forward control unit 280 does not send a grant message for port 2 (GNT_OQUEUE_2) to dequeue control unit 230 but sends a stop forward message for port 2 to forward control unit 220, such that subsequent packets cannot be queued from queue 1 to queue 2 but to queue 3 directly. Additionally, when packets in queue 2 are completely output (MCAST_CNT_2=0), output control unit 262 sends a requeue message to queue control unit 210 through dequeue control unit 230. Dequeue control unit 210 then retransmits packets from port 1 to port 2.

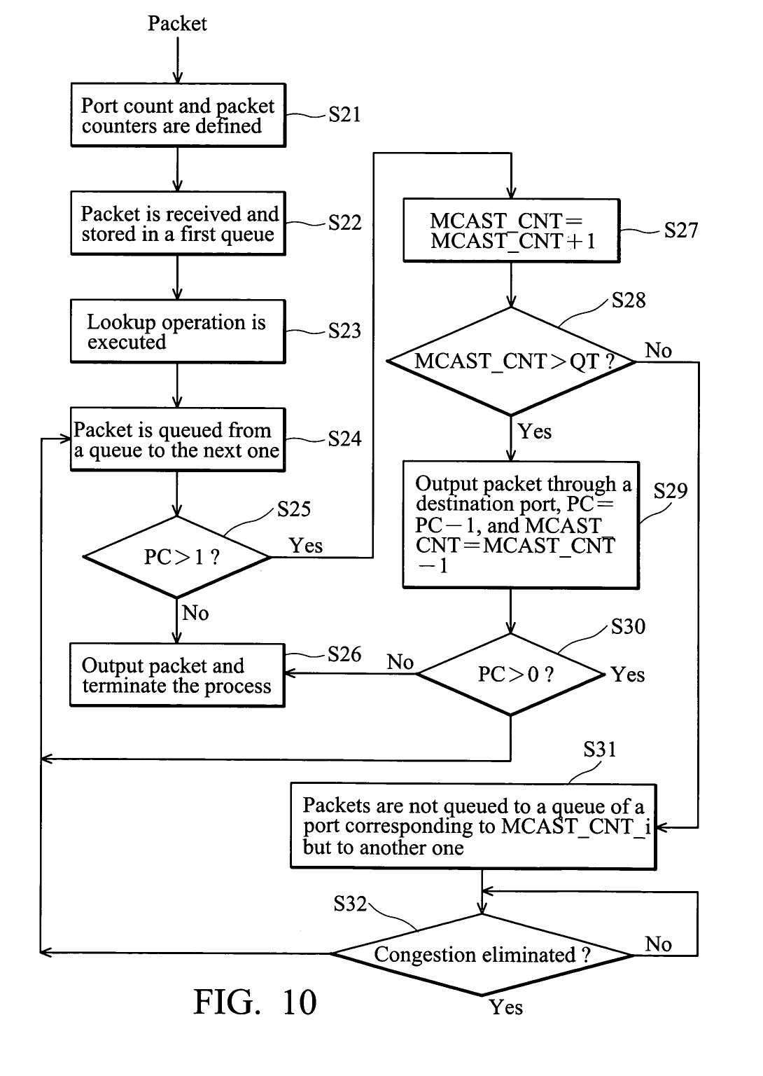

FIG. 10 is a flowchart of an embodiment of a control method for packet transmission.

A port count (PC) and packet counts for each port are first defined for packet transmission determination (step S21). When PC=1, unicast packet transmission is implemented. When PC>1, multicast or broadcast packet transmissions are implemented. Additionally, each port is assigned a packet count (MCAST_CNT_i) to calculate the number of queued packets. Next, a packet comprising a PC value is received via an input port and stored in a first queue of the input port (step S22). A lookup operation is executed according to a lookup table to locate desired destination ports (step S23). The lookup table, at least comprises port numbers and MAC addresses corresponding thereto, such that packets can be accurately transmitted to destination ports. When at least one desired destination port is located, the packet is queued from the first queue to a second queue of the desired port (step S24).

Next, it is determined whether the PC value is greater than 1 (step S25). If not, the packet is output through a destination port and the packet transmission process terminates (step S26). If so, one is added to MCAST_CNT of a port (step S27) and it is determined whether MCAST_CNT is greater than a queue threshold (QT) (step S28). If so, a copy of the packet is output through a destination port (port 2, for example) according to a grant message and MCAST_CNT and the PC value are subtracted by 1 respectively (step S29). It is determined whether the PC value of the packet is greater than 0 (step S30). If not, the packet transmission process terminates (step S26). If so, the process proceeds to step S24 and a copy of the packet should be output through another destination port (port 3, for example). If MCAST_CNT is greater than a queue threshold (QT), indicating congestion is detected, packets are not queued to a queue of a port corresponding to MCAST_CNT but to another port (step S31). It is determined whether the network congestion is eliminated (step S32), indicating packets in a congested queue are completely output. If so, the process proceeds to step 24 to requeue packets.

A control method and system for packet transmission of the invention can alleviate congestion of transmission ports of a switch to improve packet transmission in a network.

While the invention has been described by way of example and in terms of the preferred embodiments, it is to be understood that the invention is not limited to the disclosed embodiments. To the contrary, it is intended to cover various modifications-and similar arrangements (as would be apparent to those skilled in the art). Therefore, the scope of the appended claims should be accorded the broadest interpretation so as to encompass all such modifications and similar arrangements.

What is claimed is:

1. A control system for packet transmission, comprising:
a first port providing a first packet count;
a second port providing a second packet count;
a dequeue control unit;
a forward control unit, capable of receiving a packet providing a port count through an input port and implementing a lookup operation to locate desired destination ports;
a queue control unit, coupled to the forward control unit and the dequeue control unit, capable of determining whether the port count is greater than a first predetermined value, if not, outputting the packet through the first port, and, if so, sending a first message;
a multicast forward control unit, coupled to the forward control unit, the; queue control unit, and the dequeue control unit, capable of receiving the first message from the queue control unit, adding one to the first packet count, determining whether the first packet count is greater than a threshold value, and, if so, sending a stop forward message to the forward control unit but not sending a grant message;
wherein, the forward control unit receives the stop forward message and does not transmit subsequent packets to the first port but to the second port directly.

2. The control system for packet transmission as claimed in claim 1, wherein the multicast forward control unit sends a grant message to the dequeue control unit if the first packet count is not greater than the threshold value, and the dequeue control unit outputs the packet through the first port, subtracts one from the port count, and sends a subtraction message to the multicast forward control unit.

3. The control system for packet transmission as claimed in claim 3, wherein the multicast forward control unit receives the subtraction message and subtracts one from the first packet count.

4. The control system for packet transmission as claimed in claim 3, wherein the dequeue control unit determines whether the port count is greater than a second predetermined value, and, if not, the process terminates, and, if so, sends an output queuing request to the queue control unit to output the packet through the second port.

5. A control system for packet transmission, comprising:
a first port;
a second port providing a second packet count;
a third port providing a third packet count;
a storage medium, comprising a first queue applied to the first port, a second queue applied to the second port, and a third queue applied to the third port;
a dequeue control unit, coupled to the storage medium;
a forward control unit, capable of receiving a packet providing a port count through the first port, queuing the packet in the first queue, implementing a lookup operation according to a lookup table to locate desired destination ports, and transmitting the packet when the destination port determination is complete;
a queue control unit, coupled to the forward control unit, the storage medium, and the dequeue control unit, capable of receiving and queuing the packet from the first queue to the second queue, transmitting first queuing information to the storage medium, determining whether the port count is greater than a predetermined value, if not, outputting the packet through the second port, and, if so, sending a first message;
a multicast forward control unit, coupled to the forward control unit, the queue control unit, and the dequeue control unit, capable of receiving the first message from the queue control unit, adding one to the second packet count, determining whether the second packet count is greater than a threshold value, and, if so, sending a stop forward message to the forward control unit but not sending a grant message;
wherein, the forward control unit receives the stop forward message, does not queue subsequent packets from the first queue to the second queue but to the third queue directly, and requeues packets to the second queue when queued packets in the second queue are completely output.

6. The control system for packet transmission as claimed in claim 5, wherein the multicast forward control unit sends a grant message to the dequeue control unit if the second packet count is not greater than the threshold value, and the dequeue control unit retrieves the first queuing information from the storage medium, sends the first queuing information to the second port, outputs the packet through the second port, subtracts one from the second port count, and sends a subtraction message to the multicast forward control unit.

7. The control system for packet transmission as claimed in claim 6, wherein the multicast forward control unit receives the subtraction message and subtracts one from the second packet count.

8. The control system for packet transmission as claimed in claim 7, wherein the dequeue control unit determines whether the second port count is greater than a second predetermined value, and, if not, the process terminates, and, if so, sends an output queuing request to the queue control unit.

9. The control system for packet transmission as claimed in claim 8, wherein the queue control unit queues the packet from the second queue to the third queue, transmits second queuing information to the storage medium, and sends a second message to the multicast forward control unit.

10. The control system for packet transmission as claimed in claim 9, wherein the multicast forward control unit adds one to the third packet count, determines whether the third packet count is greater than the threshold value, and, if so, sends a stop forward message to the forward control unit but does not send a grant message to the dequeue control unit.

11. A control method for packet transmission, comprising:
defining a second packet count applied to a second port, a third packet count applied to a third port, and a port count;
receiving a packet through a first port and implementing a lookup operation to locate desired destination ports;
adding one to the second packet count when the port count is greater than a first predetermined value;
determining whether the second packet count is greater than a threshold value; and
if so, not transmitting subsequent packets to the second port but to the third port directly.

12. The control method for packet transmission as claimed in claim 11, further comprising:
receiving the packet through the first port and queuing the packet in a first queue;
queuing the packet from the first queue to a second queue;
outputting the packet through the second port when the port count is not greater than the first predetermined value, or adding one to the second packet count;
not queuing subsequent packets from the first queue to the second queue but to the third queue directly when the second packet count is greater than the threshold value; and
requeuing packets to the second queue when queued packets in the second queue are completely output.

13. The control method for packet transmission as claimed in claim 12, further comprising:
subtracting one from the port count when the packet is output through the second port; and
sending a subtraction message.

14. The control method for packet transmission as claimed in claim 13, further comprising subtracting one from the second packet count according to the subtraction message.

15. The control method for packet transmission as claimed in claim 14, further comprising:
determining whether the port count is greater than a second predetermined value;
if not, terminating the process; and
if so, outputting the packet through the second port and sending an output queuing request.

16. The control method for packet transmission as claimed in claim 15, further comprising:
queuing the packet from the second queue to the third queue according to the output queuing request; and
sending a second message.

17. The control method for packet transmission as claimed in claim 16, further comprising:
adding one to the third packet count according to the second message;
determining whether the third packet count is greater than the threshold value; and
if so, sending a stop forward message but not sending a grant message.
